(19) United States
(12) Patent Application Publication
(10) Pub. No.: US 2026/0132885 A1
(43) Pub. Date: May 14, 2026

(54) TRIPOD SYSTEM AND LOCKING MECHANISM

(71) Applicant: HEIWA SEIKI KOGYO CO., LTD., Saitama (JP)

(72) Inventor: Koichi YAMAGUCHI, Saitama (JP)

(21) Appl. No.: 19/252,137

(22) Filed: Jun. 27, 2025

(30) Foreign Application Priority Data
Nov. 12, 2024 (JP) 2024-197677

(51) Int. Cl. F16M 11/34

(52) U.S. Cl. CPC F16M 11/34

(57) ABSTRACT

A tripod system 100 includes: a tripod 10 comprising three legs 11 each including a first segment 111 and a second segment 112, and a first connecting portion 13 that connects the three legs 11; and a locking mechanism 20 for switching between a released state in which each leg 11 is extendable and retractable by moving the second segment 112 relative to the first segment 111, and a locked state in which the second segment 112 is fixed relative to the first segment 111, the locking mechanism 20 including three elongated connecting arms 21 each corresponding to one of the three legs 11, a second connecting portion 22 that connects the three connecting arms 21, and a gripping portion 23 provided on the second connecting portion 22, wherein each of the three connecting arms 21 is connected to the second connecting portion 22 and to the corresponding leg 11, the locked state being placed when the angle formed by each connecting arm 21 falls within a first range, and the released state being placed when the angle falls within a second range, and the gripping portion 23 has a shape that protrudes from a surface of the second connecting portion 22.

### TECHNICAL FIELD

The present invention relates to a tripod system for supporting an imaging device.

### BACKGROUND ART

Tripods used to support imaging devices (such as cameras) have been proposed. The legs of such tripods are often extendable and retractable.

For example, Patent Document 1 discloses a tripod in which each of the three legs is extendable and retractable, and the tripod can be switched between a state in which the legs can freely extend and retract (hereinafter referred to as the “released state”) and a state in which the length of the legs is fixed (hereinafter referred to as the “locked state”).

In the technique of Patent Document 1, the tripod can switch each of the three legs between the released state and the locked state by vertically moving three braces, each connected to one of the legs. These three braces are operated by a single operating knob. Specifically, the operating knob is annular in shape and formed to pass through a central shaft extending at the center of the tripod. This annular operating knob moves vertically while penetrating the central shaft. It can also be said that the central shaft serves to guide the movement of the operating knob.

### PRIOR ART DOCUMENTS

### Patent Documents

[Patent Document 1] JP-A-61-74994

### SUMMARY OF THE INVENTION

### Problem to be Solved by the Invention

However, in the technique disclosed in Patent Document 1, the operating knob is annular, making it difficult for the user to grip the knob and to operate the three braces. In other words, switching between the locked state and the released state of the legs is not easy. In view of these circumstances, the objective of the present invention is to facilitate the operation of switching between the locked state and the released state of the legs.

### Means for Solving the Problem

[1] A tripod system comprising:
   a tripod including three extendable and retractable legs each comprising a first segment and a second segment, and a first connecting portion that connects the three legs;
   a locking mechanism for switching between (i) a released state in which each leg is extendable and retractable by moving the second segment relative to the first segment, and (ii) a locked state in which the second segment is fixed relative to the first segment;
   wherein each of the three legs is connected at one end to the first connecting portion so as to pivot about a central axis, and the angle formed with respect to the central axis is changeable by pivoting about the first connecting portion;
   wherein the first segment is positioned on the side of the first connecting portion relative to the second segment when the leg is extended;
   wherein the locking mechanism includes three elongated connecting arms each corresponding to one of the three legs, a second connecting portion that connects the three connecting arms, and a gripping portion provided on the second connecting portion;
   wherein each of the three connecting arms is connected at one end to the second connecting portion so as to pivot about the central axis, and connected at the other end to the corresponding leg, and the angle formed with respect to the central axis is changeable by pivoting about the second connecting portion;
   wherein when the angle formed by each connecting arm with respect to the central axis falls within a first range, the second segment is fixed, placing the leg in the locked state, and when the angle falls within a second range, the fixation of the second segment is released, placing the leg in the released state;
   wherein the gripping portion protrudes from the surface of the second connecting portion on the side of the first connecting portion.
[2] The tripod system according to [1],
   wherein the gripping portion has a through-hole through which a user's finger can be inserted.
[3] The tripod system according to [1],
   wherein the gripping portion includes three base portions each corresponding to one of the three connecting arms,
   wherein each of the base portions is formed so as to provide a space between the base portion and the central axis, in a direction from the second connecting portion toward the first connecting portion, and
   wherein ends of the three base portions on the side opposite to the second connecting portion are connected to one another.
[4] The tripod system according to [3],
   wherein each of the base portions includes a first gripping member and a second gripping member,
   wherein the first gripping member is a portion that extends in a direction away from the central axis, as viewed from the side of the first connecting portion along the central axis, and
   wherein the second gripping member is a portion that extends from an end of the first gripping member opposite to the central axis toward the second connecting portion.
[5] The tripod system according to [3],
   wherein each of the three base portions is positioned, as viewed from the side of the first connecting portion along the central axis, at a location corresponding to a respective one of the three connecting arms.
[6] A locking mechanism for a tripod including three extendable and retractable legs each comprising a first segment and a second segment, and a first connecting portion that connects the three legs,
   the locking mechanism being for switching between
   (i) a released state in which each leg is extendable and retractable by moving the second segment relative to the first segment, and
   (ii) a locked state in which the second segment is fixed relative to the first segment,
   wherein each of the three legs is connected at one end to the first connecting portion so as to pivot about a central axis, and the angle formed with respect to the central axis is changeable by pivoting about the first connecting portion;
   wherein the first segment is positioned on the side of the first connecting portion relative to the second segment when the leg is extended;
   wherein the locking mechanism includes
   three elongated connecting arms each corresponding to one of the three legs,
   a second connecting portion that connects the three connecting arms, and
   a gripping portion provided on the second connecting portion;
   wherein each of the three connecting arms is connected at one end to the second connecting portion so as to pivot about the central axis, and connected at the other end to the corresponding leg, and the angle formed with respect to the central axis is changeable by pivoting about the second connecting portion;
   wherein when the angle formed by each connecting arm with respect to the central axis falls within a first range, the second segment is fixed, placing the leg in the locked state, and when the angle falls within a second range, the fixation of the second segment is released, placing the leg in the released state;
   wherein the gripping portion protrudes from a surface of the second connecting portion on the side of the first connecting portion.

### Effects of the Invention

According to the present invention, the operation of switching between the locked state and the released state of the legs is facilitated.

### BRIEF DESCRIPTION OF THE DRAWINGS

FIG. 1 Perspective view of the tripod system according to an embodiment.

FIG. 2 Perspective view of the tripod system according to an embodiment.

FIG. 3 Perspective view of the locking mechanism according to an embodiment.

FIG. 4 Illustrative view showing how the locking mechanism switches between the locked state and the released state in the embodiment.

FIG. 5 Top view of the gripping portion according to an embodiment.

FIG. 6 Side view of the gripping portion according to an embodiment.

FIG. 7 Perspective view of the gripping portion according to an embodiment.

FIG. 8 Perspective view of the tripod system according to a modified example.

FIG. 9 Side view of the gripping portion according to a modified example.

FIG. 10 Side view of the gripping portion according to a modified example.

### MODE FOR CARRYING OUT THE INVENTION

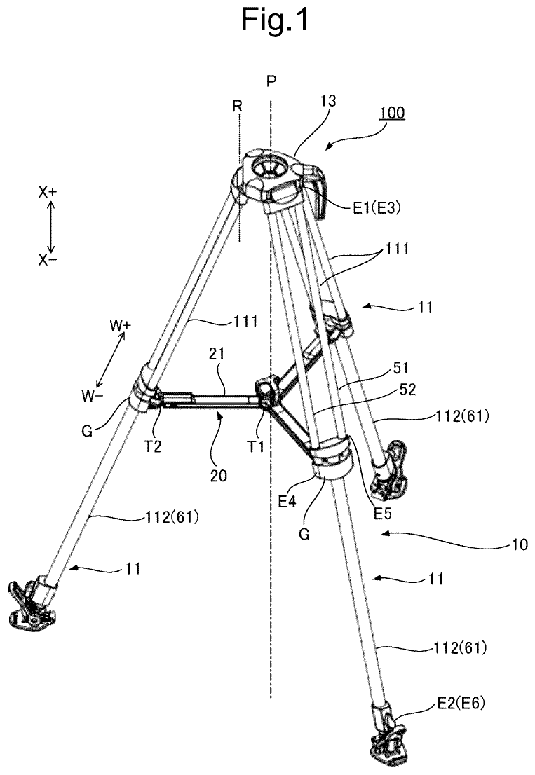

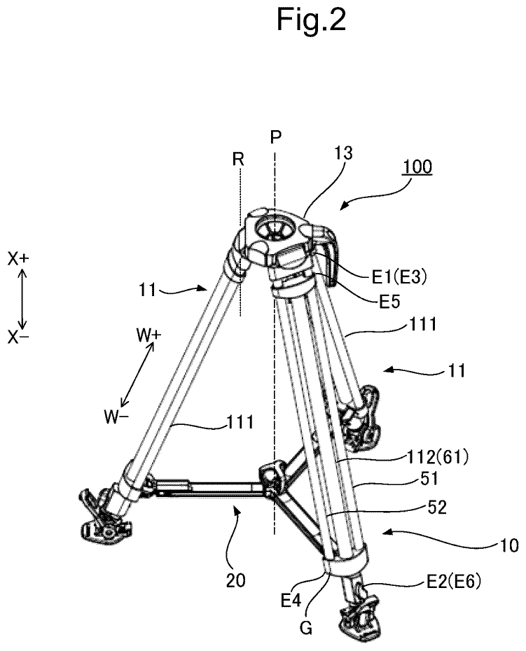

FIG. 1 and FIG. 2 are perspective views of a tripod system 100 according to the present embodiment. The tripod system 100 is a device for supporting an imaging device (e.g., a camera). As illustrated in FIGS. 1 and 2, a tripod 10 includes legs 11 and a locking mechanism 20.

The tripod 10 includes three extendable and retractable legs 11 and a first connecting portion 13 that connects the three legs 11. The first connecting portion 13 is provided, for example, with various mounting devices (such as a tripod head or an adapter) for attaching an imaging device, and the imaging device is fixed to the tripod 10 via such a mounting device.

In outline, the tripod 10 is capable of switching between a state in which the length of each leg 11 can be extended and retracted (hereinafter referred to as the “released state”) and a state in which the length of each leg 11 is fixed (hereinafter referred to as the “locked state”). FIG. 1 shows a state in which each leg 11 is fully extended, and FIG. 2 shows a state in which each leg 11 is fully retracted.

In the following description, since the three legs 11 have the same structure, one of the legs 11 will be described as a representative example. FIGS. 1 and 2 also illustrate the W direction, which is the direction along which the leg 11 extends. The leg 11 in the present embodiment includes, for example, a first segment 111 and a second segment 112. As illustrated in FIG. 1, when the leg 11 is extended, the first segment 111 is located on the positive side(W+) of the W direction (i.e., the side of the first connecting portion 13) relative to the second segment 112.

The first segment 111 and the second segment 112 are elongated members extending along the W direction. In the first embodiment, the first segment 111 includes, for example, a first shaft member 51 and a second shaft member 52 that extend along the W direction. The first member 51 and the second member 52 are arranged with a space therebetween. The shapes of the first member 51 and the second member 52 are not particularly limited, and may be cylindrical or polygonal.

The second segment 112 includes a third member 61. The third member 61 is a shaft-like member extending along the W direction. As illustrated in FIG. 2, in the present embodiment, when the leg 11 is in a retracted state, the third member 61 is positioned between the first member 51 and the second member 52, and is movable along the W direction between the first member 51 and the second member 52. The shape of the third member 61 is not particularly limited, and may be cylindrical or polygonal.

The leg 11 can be extended and retracted by relatively moving the second segment 112 with respect to the first segment 111. In other words, the leg 11 can be extended and retracted by changing the overlapping range between the first segment 111 and the second segment 112. In the present embodiment, the overlapping range between the first segment 111 and the second segment 112 is adjusted by changing the length of the section of the third member 61 that is positioned between the first member 51 and the second member 52. When the leg 11 is in its fully extended state, the overlapping range between the first segment 111 and the second segment 112 is the shortest (i.e., the section of the third member 61 positioned between the first member 51 and the second member 52 is the shortest). On the other hand, when the leg 11 is in its fully retracted state, the overlapping range between the first segment 111 and the second segment 112 is the longest (i.e., the section of the third member 61 positioned between the first member 51 and the second member 52 is the longest). The overlapping range between the first segment 111 and the second segment 112 may also be described as the range in the W direction in which the first segment 111 and the second segment 112 are located at approximately the same position.

In the present disclosure, the released state refers to a state in which the leg 11 can be extended and retracted by moving the second segment 112 relative to the first segment 111, while the locked state refers to a state in which the second segment 112 is fixed relative to the first segment 111 (that is, the second segment 112 cannot move). The switching between the released state and the locked state can be performed by the locking mechanism 20. Details of the locking mechanism 20 will be described later.

In the following description, the end on the positive side (W+) in the W direction of the leg 11 is referred to as “end E1,” and the end on the negative side (W−) in the W direction of the leg 11 is referred to as “end E2.” In addition, one end of the first segment 111 is referred to as “end E3,” the other end of the first segment 111 as “end E4,” one end of the second segment 112 as “end E5,” and the other end of the second segment 112 as “end E6.” Ends E3 and E5 are the ends on the side of the first connecting portion 13 (i.e., the positive side (W+) in the W direction), and ends E4 and E6 are the ends on the side opposite to the first connecting portion 13 (i.e., the negative side (W−) in the W direction). In the present embodiment, an example is illustrated in which end E1 of the leg 11 corresponds to end E3 of the first segment 111, and end E2 of the leg 11 corresponds to end E6 of the second segment 112.

As shown in FIG. 1, in the present embodiment, the first segment 111 includes a support portion G at end E4. The support portion G is a component that supports the second segment 112 so as to be movable along the W direction between the first member 51 and the second member 52. For example, the first member 51 and the second member 52 are fixed to the support portion G, and the second segment 112 (the third member 61) is supported so as to be movable along the W direction in a state where it passes through an insertion hole provided in the support portion G.

The first connecting portion 13 connects the three legs 11 so as to be pivotable. In other words, each leg 11 can pivot about the first connecting portion 13 as a base point. Each of the three legs 11 is connected to the first connecting portion 13 at its end E1 (the end on the positive side (W+) in the W direction), with respect to a central axis P. In the present embodiment, end E3 of the first segment 111 is connected to the first connecting portion 13. Each of the three legs 11 pivots about a pivot axis R that extends in a different direction. By pivoting about the first connecting portion 13, each leg 11 changes the angle it forms relative to the central axis P.

The three legs 11 are connected to the first connecting portion 13 such that the three pivot axes R of the respective legs form a triangle whose vertices are defined by the intersections of the axes (typically forming an equilateral triangle). In other words, the pivot axes R of two adjacent legs 11, arranged along the circumferential direction around the central axis P, intersect at an angle of 60 degrees. The central axis P passes through the center of the triangle formed by the pivot axes R of the legs and is perpendicular to that triangle.

The shape of the first connecting portion 13 is not particularly limited, as long as it allows the three legs 11 to be pivotably connected and enables a mounting device for installing an imaging device to be provided on the surface opposite to the side where the ends E2 of the legs 11 are located.

As the leg 11 pivots, the end E2 moves either away from or toward the central axis P. In other words, the central axis P may be described as an axis that passes through the center of an equilateral triangle formed by the three ends E2 of the legs 11 when they are in their most widely opened positions.

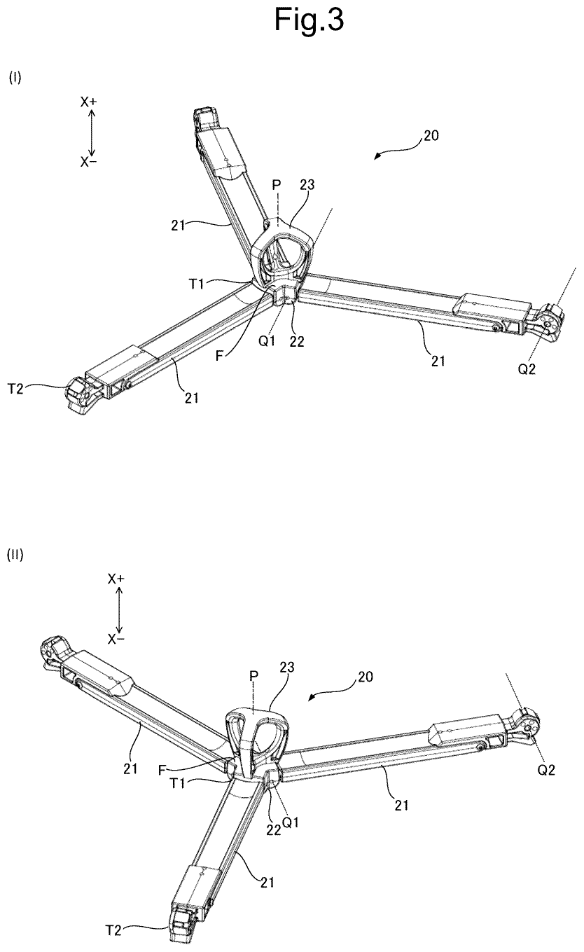

FIG. 3 is a perspective view focusing on the locking mechanism 20. FIG. 3 shows two perspective views from different angles, labeled (I) and (II). As shown in FIG. 3, the locking mechanism 20 includes three elongated connecting arms 21, a second connecting portion 22 that connects the three connecting arms 21, and a gripping portion 23 provided on the second connecting portion 22.

As shown in FIG. 1, one end T1 of each connecting arm 21 is connected to the second connecting portion 22. The second connecting portion 22 pivotably connects the three connecting arms 21. In other words, each connecting arm 21 can pivot about the second connecting portion 22 as a base point. Each of the three connecting arms 21 pivots about a pivot axis Q1 that extends in a different direction. The three connecting arms 21 have the same length.

The three connecting arms 21 are connected to the second connecting portion 22 such that the intersections of their respective pivot axes Q1 form the vertices of a triangle (typically an equilateral triangle). In other words, the pivot axes Q1 of two adjacent connecting arms 21, arranged along the circumferential direction around the central axis P, intersect at an angle of 60 degrees. The central axis P passes through the center of the triangle formed by the three intersections of the pivot axes Q1. That is, the end T1 of each connecting arm 21 is connected to the second connecting portion 22 with respect to the central axis P.

The other end T2 of each connecting arm 21 is connected to the corresponding leg 11. In the present embodiment, the end T2 of the connecting arm 21 is connected to end E4 of the first segment 111 of the leg 11 (i.e., the end opposite to the first connecting portion 13). In this embodiment, the end T2 of the connecting arm 21 is pivotally connected to the support portion G located at end E4 of the first segment 111. As described above, in the present embodiment, the end T2 of the connecting arm 21 is connected to end E4 of the first segment 111 via the support portion G.

Each connecting arm 21 changes the angle it forms with respect to the central axis P by pivoting about the second connecting portion 22. When the connecting arm 21 pivots about a pivot axis Q2, the end T2 of the connecting arm 21 moves either away from or toward the central axis P. In other words, the connecting arm 21 is pivotable while being connected to both the second connecting portion 22 and the second segment 112. It can also be said that the connecting arm 21 is capable of pivoting about both the pivot axis Q1 at the second connecting portion 22 and the pivot axis Q2 at the second segment 112. The pivot axes Q1 and Q2 are parallel to each other. The central axis P passes through the center of an equilateral triangle whose vertices are defined by the three connecting arms 21 when they are in the most widely opened state (i.e., when the respective ends T2 are at the greatest distance from one another). The X direction shown in FIG. 1 is a direction parallel to the central axis P.

However, in the present disclosure, it is not essential that the end T2 of the connecting arm 21 be connected to end E4 of the first segment 111, or that it be connected to the support portion G of the first segment 111. As long as the end T2 of the connecting arm 21 is pivotably connected to the leg 11, and the locking mechanism 20 is capable of fixing and releasing the second segment 112, neither the specific connection point of the end T2 nor the connection method between the leg 11 and the end T2 of the connecting arm 21 is particularly limited. For example, a configuration may be adopted in which the end T2 of the connecting arm 21 is connected to end E5 of the second segment 112 of the leg 11.

As shown in FIG. 1, the gripping portion 23 is provided on the surface F of the second connecting portion 22 that faces the first connecting portion 13 (i.e., the surface on the imaging device side). The gripping portion 23 is the part that the user grips when switching between the locked state and the released state. By gripping the gripping portion 23 and moving it in the vertical direction (the positive and negative directions along the X axis), the user can change the angle (hereinafter referred to as the “pivot angle θ”) that each connecting arm 21 forms with respect to the central axis P.

The pivot angles θ of the three connecting arms 21 are essentially the same. The three connecting arms 21 can be operated by a single common gripping portion 23. The gripping portion 23 has a shape that protrudes from the surface F of the second connecting portion 22 on the side of the first connecting portion 13. The specific shape of the gripping portion 23 will be described later. The shape of the second connecting portion 22 is not particularly limited, as long as it can pivotably connect the three connecting arms 21 and allows the gripping portion 23 to be provided on the surface F of the second connecting portion 22 facing the first connecting portion 13. In addition, the pivoting of the three connecting arms 21 causes the three legs 11 to pivot in conjunction.

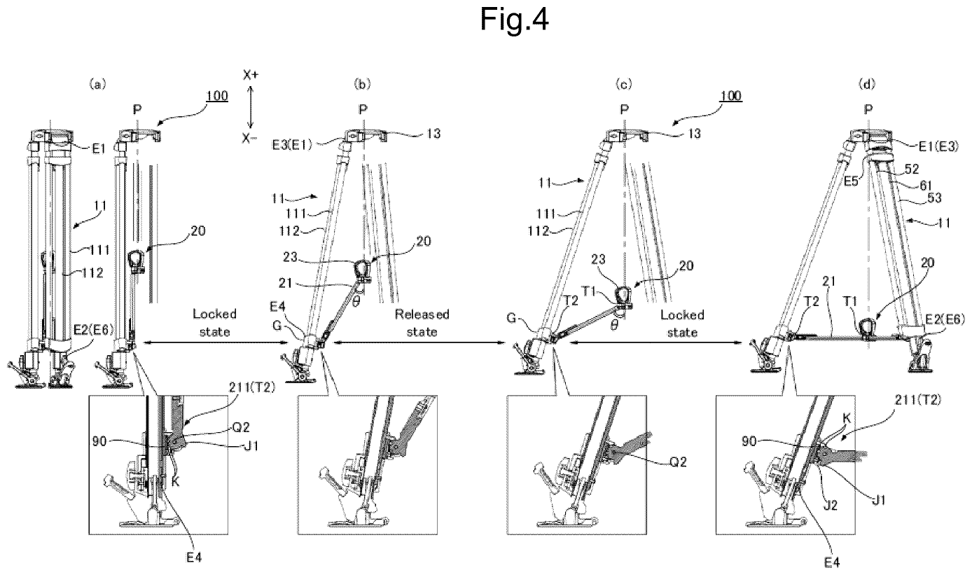

FIG. 4 is an illustrative view for explaining how the locking mechanism 20 switches between the locked state and the released state. In FIG. 4, some portions of the leg 11 and the connecting arm 21 are omitted as appropriate. FIG. 4 shows four different states—(a), (b), (c), and (d)—each having a different pivot angle θ of the connecting arm 21. As described above, the locking mechanism 20 switches between the locked state and the released state by changing the pivot angle θ of the connecting arm 21.

As shown in FIG. 4, state (a) represents the condition in which the pivot angle θ of the connecting arm 21 is the smallest (i.e., closest to 0°), and state (d) represents the condition in which the pivot angle θ is the largest (i.e., closest to 90°). In other words, the connecting arm 21 is pivotable within a range between the angle in state (a) (hereinafter referred to as “angle A”) and the angle in state (d) (hereinafter referred to as “angle D”).

When the pivot angle θ of the connecting arm 21 is between (a) and (b), the legs 11 are in the locked state. When the pivot angle θ is between (b) and (c), the legs 11 is in are the released state. When the pivot angle θ is between (c) and (d), the legs 11 return to the locked state. When the connecting arm 21 is between (b) and (c), the user can adjust the leg 11 to a desired length (for example, the state shown in FIG. 1), and then bring the connecting arm 21 to state (d) to make the tripod system 100 ready for use.

When the pivotable range of the connecting arm 21 (i.e., angle A to angle D) is divided into three sections from angle A—namely, a first section, a second section, and a third section—the first section [(a) to (b)] and the third section [(c) to (d)] correspond to the locked state, while the second section [(b) to (c)] corresponds to the released state.

As understood from the above description, when the pivot angle θ of the connecting arm 21 is within the first section (an example of the “first range”) or the third section (also an example of the “first range”), the locking mechanism 20 fixes the second segment 112 (i.e., restricts the movement of the second segment 112), thereby placing the legs 11 in the locked state. On the other hand, when the pivot angle θ of the connecting arm 21 is within the second section (an example of the “second range”), the locking mechanism 20 releases the fixation of the second segment 112 (i.e., allows the movement of the second segment 112), thereby placing the legs 11 in the released state.

An example of a specific configuration for switching between the released state and the locked state by changing the pivot angle θ of the connecting arm 21 is described below. As shown in FIG. 4, the end T2 of the connecting arm 21 includes, for example, an eccentric mechanism 211. On the other hand, end E4 of the first segment 111 (i.e., the support portion G) includes a contact portion 90.

The eccentric mechanism 211 pivots about the pivot axis Q2. A cross-sectional view of the eccentric mechanism 211 is also shown in FIG. 4. As shown in FIG. 4, the eccentric mechanism 211 includes portions where the distance from the pivot axis Q2 to the outer peripheral edge (i.e., the radial length) varies in the circumferential direction. In the present embodiment, the eccentric mechanism 211 includes two portions where the distance from the pivot axis Q2 to the outer periphery is greater than that of other portions (these are referred to as “protrusions K”). When the connecting arm 21 pivots about the pivot axis Q2 and the protrusion K (shown in FIG. 4 as a hollow circular region) presses against the contact portion 90, the contact portion 90 moves to press against the outer peripheral surface of the second segment 112. As a result, the second segment 112 is fixed by the contact portion 90. When the pressure from the protrusion K is released, the pressure applied by the contact portion 90 to the outer surface of the second segment 112 is also released, thereby allowing the second segment 112 to move. The contact portion 90 is disposed at end E4 of the first segment 111 so as to be able to contact the outer peripheral surface of the second segment 112. For example, the contact portion 90 contacts the outer surface of the part of the second segment 112 located inside the support portion G, via a through-hole formed in the support portion G.

In FIG. 4, state (a) shows a condition in which one of the protrusions K presses against the contact portion 90. When the connecting arm 21 pivots and moves to state (b), the pressure from that protrusion K is released. As the arm moves from state (b) to state (c), the other protrusion K comes into contact and begins pressing against the contact portion 90. Then, from state (c) to state (d), the other protrusion K continues to press against the contact portion 90.

However, the specific configuration of the eccentric mechanism 211 is not particularly limited, as long as the first section [(a) to (b)] and the third section [(c) to (d)] correspond to the locked state, and the second section [(b) to (c)] corresponds to the released state. In addition, a structure other than the eccentric mechanism 211 may be used, as long as the first section [(a) to (b)] and the third section [(c) to (d)] result in the locked state and the second section [(b) to (c)] results in the released state.

The eccentric mechanism 211 may include an engaging portion J1 that engages with the leg 11 when the connecting arm 21 is in state (d). In an embodiment in which the engaging portion J1 is provided at the end T2 of the connecting arm 21, the tripod 10 can be stably fixed. The engaging portion J1 is a protruding part that, during pivoting of the connecting arm 21 about the pivot axis Q2, does not engage with the leg 11 until the connecting arm 21 reaches state (d), but engages with the leg 11 when the connecting arm 21 reaches state (d). The engaging portion J1 may also be described as a component that prevents the pivot angle θ of the connecting arm 21 from exceeding the pivot angle corresponding to state (d). For example, the engaging portion J1 engages with a projection J2 provided near the contact portion 90 at end E4 of the first segment 111 of the leg 11 (i.e., at the support portion G).

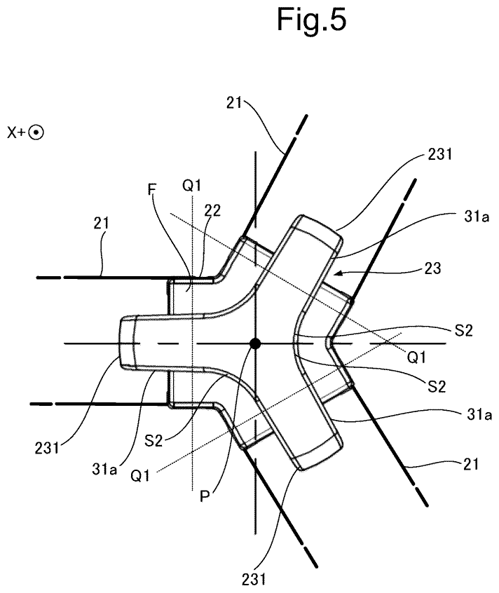

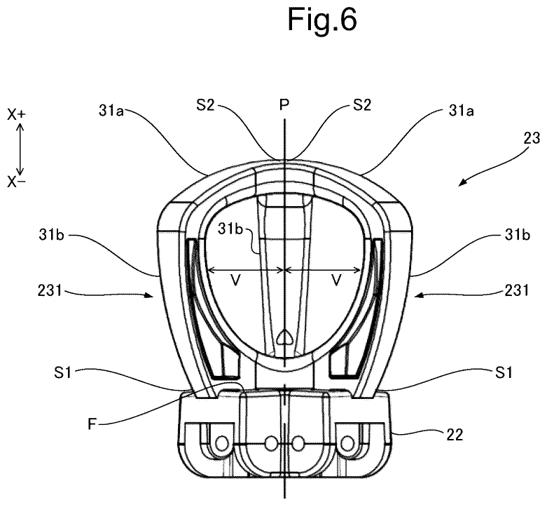

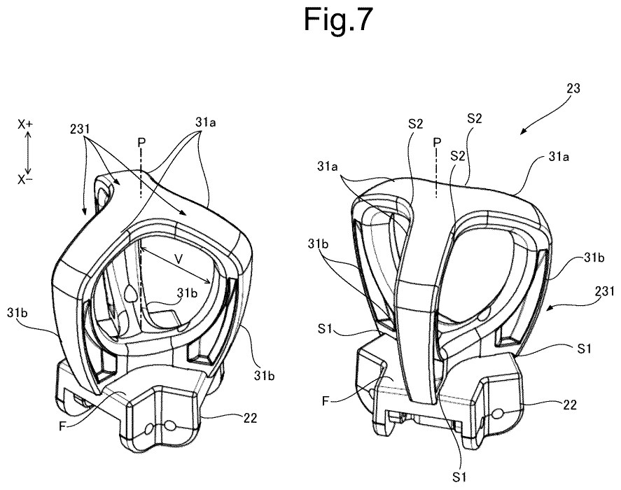

The following describes the specific configuration of the gripping portion 23. FIG. 5 is a top view showing the gripping portion 23 as seen from the positive side (X+) in the X direction. FIG. 6 is a side view showing the gripping portion 23 as seen from a direction orthogonal to the X direction. FIG. 7 is a perspective view of the gripping portion 23.

As shown in FIGS. 5 through 7, the gripping portion 23 in the present embodiment includes three base portions 231, each corresponding to one of the three connecting arms 21. As shown in FIG. 5, in the present embodiment, each of the three base portions 231 is located at a position corresponding to one of the three connecting arms 21 when viewed from the positive side (X+) in the X direction (i.e., the side of the first connecting portion 13 along the central axis P). For example, when viewed from the positive side (X+) in the X direction, each base portion 231 is positioned so as to overlap with the corresponding connecting arm 21.

As shown in FIGS. 6 and 7, each base portion 231 in the present embodiment is formed so as to protrude from the surface F of the second connecting portion 22 toward the side of the first connecting portion 13 (i.e., the positive side (X+) in the X direction). Specifically, each base portion 231 is formed so as to curve from the second connecting portion 22 toward the side of the first connecting portion 13 of the tripod 10 (i.e., the positive side (X+) in the X direction), in a direction away from the central axis P. In other words, each base portion 231 is formed such that a space V is provided between the base portion 231 and the central axis P. If a space V is provided between the central axis P and the base portion 231, it is not essential for the base portion 231 to be curved. For example, the space V may be formed by the base portion 231 including an angled section or a straight section.

One end S1 of the base portion 231 is located on the surface F side of the second connecting portion 22, and the other end S2 of the base portion 231 is positioned closer to the first connecting portion 13 of the tripod 10 than the end S1 (i.e., on the positive side (X+) in the X direction). The respective ends S2 (i.e., the ends opposite to the second connecting portion 22) of the three base portions 231 are connected to each other. As can be seen from FIG. 5, the three base portions 231 are formed at different positions along the circumferential direction around the central axis P. Typically, the three base portions 231 are arranged at 120° intervals along the circumferential direction of the central axis P. A space defined by the inner sides of the three base portions 231 is formed.

As shown in FIGS. 6 and 7, the base portion 231 in the present embodiment includes a first gripping member 31a and a second gripping member 31b.

As shown in FIG. 5, each first gripping member 31a is a portion that extends outward from the central axis P when viewed from the positive side (X+) in the X direction (i.e., the side of the first connecting portion 13 along the central axis P). The three first gripping members 31a are arranged at different positions along the circumferential direction around the central axis P (in FIG. 5, they are spaced at 120° intervals along the circumferential direction). As shown in FIGS. 6 and 7, each second gripping member 31b is a portion that extends from the end of the corresponding first gripping member 31a on the side opposite to the central axis P toward the second connecting portion 22.

When the three base portions 231 are referred to as a first base portion, a second base portion, and a third base portion in order along the circumferential direction of the central axis P, the spaces between the first and second base portions, between the second and third base portions, and between the third and first base portions are each separated from one another (in other words, gaps are formed). A space can be defined within the interior of the three base portions 231. A finger can be inserted from between the first and second base portions and passed through to both the space between the second and third base portions and the space between the third and first base portions. Likewise, a finger can be inserted from between the second and third base portions and passed through the spaces between the third and first base portions and between the first and second base portions. Similarly, a finger can be inserted from between the third and first base portions and passed through the spaces between the second and third base portions and between the first and second base portions. That is, the spaces between the first and second base portions, between the second and third base portions, and between the third and first base portions are all in communication with one another. As understood from the above description, the gripping portion 23 in the present embodiment can be regarded as having a through-hole through which the user's fingers can pass.

Since the gripping portion 23 of the locking mechanism 20 in the present embodiment protrudes from the surface of the second connecting portion 22 on the side of the first connecting portion 13, it is easy for the user to grip and facilitates the vertical movement (i.e., in the positive and negative directions of the X axis) of the locking mechanism 20. In other words, the operation of switching between the locked state and the released state of the leg 11 is made easier. In the present invention, the central axis P may also be defined as an imaginary straight line passing through the center of the first connecting portion 13 and the center of the gripping portion 23 and the second connecting portion 22.

### Modified Example

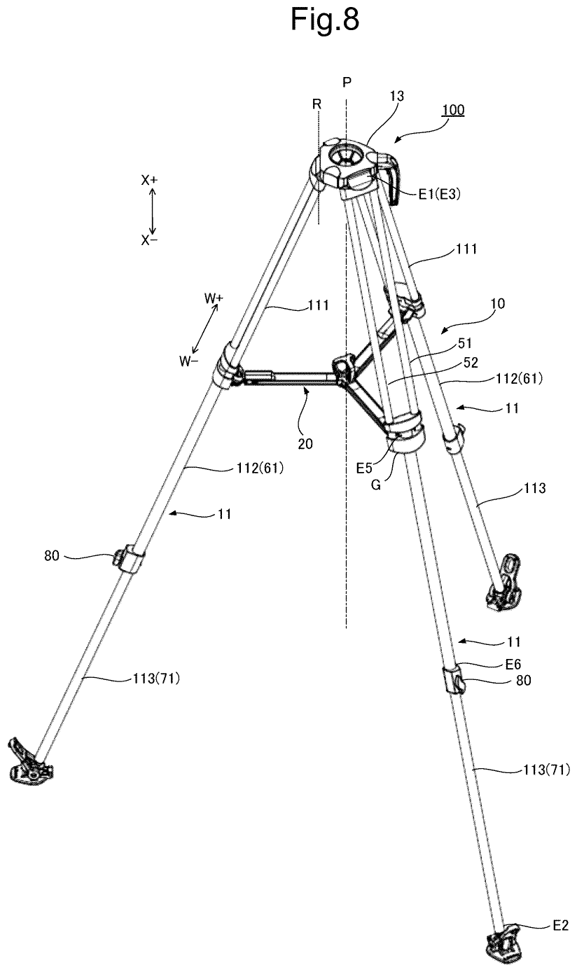

The embodiment illustrated above can be modified in various ways. Specific examples of modifications applicable to the above-described embodiment are provided below. Two or more of the examples described below may be appropriately combined, as long as they are not mutually inconsistent.
(1) The tripod system 100 of the present invention is not limited to the embodiment described above. The present invention may be applied to various types of tripod systems 100 that hold different imaging devices, such as large imaging devices, small imaging devices, remotely operable imaging devices (e.g., PTZ cameras), or terminal devices equipped with imaging devices (e.g., smartphones).
(2) In the above embodiment, a configuration in which the leg 11 includes a first segment 111 and a second segment 112 was illustrated. However, as shown in FIG. 8, the leg 11 may further include a third segment 113 in addition to the first segment 111 and the second segment 112. The third segment 113 is located on the side of the first connecting portion 13 relative to the first segment 111 when the leg 11 is extended, and the length of each leg 11 can be further adjusted by changing the overlapping range between the second segment 112 and the third segment 113. For example, the third member 61 of the second segment 112 may be a tubular member, and the third segment 113 may include a fourth member 71 in the form of a shaft extending in the W direction, which can be accommodated within the third member 61. By adjusting the section of the fourth member 71 that is exposed from the third member 61, the overlapping range between the second segment 112 and the third segment 113 is changed. The longer the section of the third segment 113 that is exposed from the second segment 112, the longer the leg 11 becomes. The locking and releasing between the second segment 112 and the third segment 113 is performed, for example, by a known locking mechanism 80 provided at end E6 of the second segment 112.

An additional segment may be provided further toward the first connecting portion 13 beyond the first segment 111. As understood from the above description, the leg 11 may be composed of three or more segments. In a configuration in which the leg 11 includes three or more segments, at least two of the segments (e.g., the first segment and the second segment) among the three or more segments may be locked and released by the locking mechanism 20. However, it is also possible for the locking mechanism 20 to switch between the locked and released states for all of the segments.

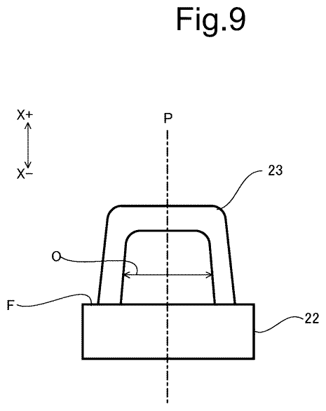

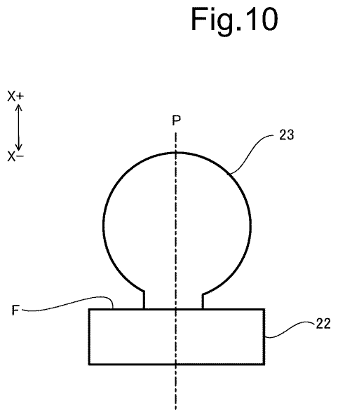

The configurations of the first segment 111 and the second segment 112 are not limited to those described in the above embodiment. For example, a configuration in which the first segment 111 is composed of a single elongated member extending in the W direction, or a configuration in which the second segment 112 is composed of two or more shaft-shaped members, may also be adopted.
(3) In the above embodiment, for example, a configuration may be adopted in which the first segment 111 includes a tubular member, and the second segment 112 is configured to be accommodated within the tubular member. In this configuration, the overlapping range between the first segment 111 and the second segment 112 is adjusted by changing the section of the second segment 112 that is exposed from the tubular member of the first segment 111. Increasing the exposed length of the second segment 112 from the first segment 111 increases the overall length of the leg 11.
(4) The shape of the gripping portion 23 is not limited to the embodiment described above, as long as it protrudes from the surface F on the side of the first connecting portion 13 of the second connecting portion 22. For example, as shown in FIG. 9, the gripping portion 23 may have a shape including a through-hole O extending in the X direction (i.e., a space through which a finger can pass). Alternatively, as shown in FIG. 10, the gripping portion 23 may have a configuration without a through-hole, in which a protrusion is formed that can be gripped from the surface F of the second connecting portion 22. However, in the configuration having a through-hole (space) through which a finger can pass, as in the embodiment shown in FIG. 6 or FIG. 9, there is an advantage over the configuration of FIG. 10 in that the gripping portion 23 is easier to grasp while also contributing to weight reduction. Furthermore, in the embodiment in which a space is formed by the three gripping portions 23, as described above, the gripping portion 23 is even easier to grasp compared to, for example, the configuration shown in FIG. 9.

Furthermore, in the above embodiment, each of the three base portions 231 is located on top of a corresponding one of the three second connecting portions 22 when viewed from the positive side in the X direction. However, for example, each base portion 231 may instead be positioned between two connecting arms 21. Nevertheless, in the embodiment in which each of the three base portions 231 is positioned on top of a corresponding one of the three second connecting portions 22, there is an advantage in that the force applied by the user when moving the gripping portion 23 is easily transmitted to each connecting arm 21, making it easier to move the connecting arms 21 along the X direction.
(5) The shapes of the three base portions 231 may be arbitrary, as long as a space that can accommodate a finger can be defined within the interior of the three base portions 231. However, in a configuration in which each base portion 231 includes a first gripping member 31a that extends outward from the central axis P when viewed from the positive side in the X direction, and a second gripping member 31b that connects the first gripping member 31a to the second connecting portion 22, there is an advantage in that the user can easily hook a finger onto the first gripping member 31a.

### DESCRIPTION OF REFERENCE SIGNS

10: Tripod
11: Leg
13: First connecting portion
20: Locking mechanism
21: Connecting arm
22: Second connecting portion
23: Gripping portion
51: First member
52: Second member
61: Third member
31a: First gripping member
31b: Second gripping member
90: Contact portion
100: Tripod system
111: First segment
112: Second segment
211: Eccentric mechanism
231: Base portion
J1: Engaging portion
J2: Projection
P: Central axis

1. A tripod system comprising:
a tripod including three extendable and retractable legs each comprising a first segment and a second segment, and a first connecting portion that connects the three legs;
a locking mechanism for switching between
(i) a released state in which each leg is extendable and retractable by moving the second segment relative to the first segment, and (ii) a locked state in which the second segment is fixed relative to the first segment;
wherein each of the three legs is connected at one end to the first connecting portion so as to pivot about a central axis, and the angle formed with respect to the central axis is changeable by pivoting about the first connecting portion;
wherein the first segment is positioned on the side of the first connecting portion relative to the second segment when the leg is extended;
wherein the locking mechanism includes three elongated connecting arms each corresponding to one of the three legs, a second connecting portion that connects the three connecting arms, and a gripping portion provided on the second connecting portion;
wherein each of the three connecting arms is connected at one end to the second connecting portion so as to pivot about the central axis, and connected at the other end to the corresponding leg, and the angle formed with respect to the central axis is changeable by pivoting about the second connecting portion;
wherein when the angle formed by each connecting arm with respect to the central axis falls within a first range, the second segment is fixed, placing the leg in the locked state, and when the angle falls within a second range, the fixation of the second segment is released, placing the leg in the released state;
wherein the gripping portion protrudes from the surface of the second connecting portion on the side of the first connecting portion.

2. The tripod system according to claim 1,
wherein the gripping portion has a through-hole through which a user's finger can be inserted.

3. The tripod system according to claim 1,
wherein the gripping portion includes three base portions each corresponding to one of the three connecting arms,
wherein each of the base portions is formed so as to provide a space between the base portion and the central axis, in a direction from the second connecting portion toward the first connecting portion, and
wherein ends of the three base portions on the side opposite to the second connecting portion are connected to one another.

4. The tripod system according to claim 3,
wherein each of the base portions includes a first gripping member and a second gripping member,
wherein the first gripping member is a portion that extends in a direction away from the central axis, as viewed from the side of the first connecting portion along the central axis, and
wherein the second gripping member is a portion that extends from an end of the first gripping member opposite to the central axis toward the second connecting portion.

5. The tripod system according to claim 3,
wherein each of the three base portions is positioned, as viewed from the side of the first connecting portion along the central axis, at a location corresponding to a respective one of the three connecting arms.

6. A locking mechanism for a tripod including three extendable and retractable legs each comprising a first segment and a second segment, and a first connecting portion that connects the three legs,
the locking mechanism being for switching between
(i) a released state in which each leg is extendable and retractable by moving the second segment relative to the first segment, and
(ii) a locked state in which the second segment is fixed relative to the first segment,
wherein each of the three legs is connected at one end to the first connecting portion so as to pivot about a central axis, and the angle formed with respect to the central axis is changeable by pivoting about the first connecting portion;
wherein the first segment is positioned on the side of the first connecting portion relative to the second segment when the leg is extended;
wherein the locking mechanism includes
three elongated connecting arms each corresponding to one of the three legs,
a second connecting portion that connects the three connecting arms, and
a gripping portion provided on the second connecting portion;
wherein each of the three connecting arms is connected at one end to the second connecting portion so as to pivot about the central axis, and connected at the other end to the corresponding leg, and the angle formed with respect to the central axis is changeable by pivoting about the second connecting portion;
wherein when the angle formed by each connecting arm with respect to the central axis falls within a first range, the second segment is fixed, placing the leg in the locked state, and when the angle falls within a second range, the fixation of the second segment is released, placing the leg in the released state;
wherein the gripping portion protrudes from a surface of the second connecting portion on the side of the first connecting portion.
